(19) United States
(12) Patent Application Publication
(10) Pub. No.: US 2026/0319651 A1
(43) Pub. Date: Oct. 15, 2026

(54) Scrollable document generation

(71) Applicant: Canva Pty Ltd, Surry Hills, NSW (AU)

(72) Inventors: Marc Michael Fallows, Sunrise Beach (AU); Mathew James Paul Manning, Thornbury (AU); Christian Klammer, Preston (AU); Yue Yang Ho, Carlton (AU); I-Sheng Lin, Sydney (AU); Kirsten Erika Monique Hendriks, Mountain River (AU); Charlton Bruce Litchfield Groves, Surry Hills (AU); Céline May Rufener, Auckland (NZ); Xueqing Jiang, Sydney (AU)

(73) Assignee: Canva Pty Ltd, Surry Hills, NSW (AU)

(21) Appl. No.: 19/176,408

(22) Filed: Apr. 11, 2025

(51) Int. Cl. G06F 3/0485; G06F 16/93

(52) U.S. Cl. CPC G06F 3/0485; G06F 16/93

(57) ABSTRACT

Described herein are computer implemented methods relating to generating dynamic scrollable documents. Time-varying content is mapped to scroll distance in a scrollable document. Techniques for optimizing the time-varying content are described. Page structures and page displays for the mapped content are described. Processes that support on-demand generation of the scrollable content, as well as editing workflows are described.

### FIELD

The present disclosure is directed to systems and methods for creating, generating or editing scrollable documents and to systems and methods for displaying scrollable documents, in particular dynamic scrollable documents.

### BACKGROUND

Scrollable documents or in other words documents that include content in the form of one or more scrollable elements, parts or designs, enable users to explore and interact with content that exceeds the physical dimensions of a display on which the user is viewing the content, providing a more flexible and adaptable way to work with and view information.

Creating a static scrollable document is relatively routine and many examples exist, for example a document spanning several pages, through which a reader may scroll. A user may operate a user interface device to cause scrolling. For example, a user may operate a scroll wheel on a point and click device, and rotation of the scroll wheel may be mapped to a viewport on the document shifting by a certain number of pixels. The user may also perform other input operations, such as selecting a scroll button, dragging a scroll bar, selecting a position along a scroll track or scroll area and others.

Creating a dynamic scrollable document, such as a scrollytelling type document is more complex. The dynamic scrollable document may include any of various different types of dynamic content that is triggered, synced or otherwise controlled by user scroll input, such as animations, animated transitions, interactions with elements in the document, parallax scrolling effects, parts of the content remaining fixed on the screen (sticky elements) whilst others move, interactive data visualizations or scrolling-based page layouts that rearrange content as the user scrolls. Dynamic scrollable documents can provide an immersive way to scroll through content.

A dynamic scrollable document in the form of a web page may be created using some Web builder tools. One approach is to define animations for each element on the page to achieve the scrolling of the element, parts or designs within the document. Some techniques are relatively complex to learn or implement and some may provide limited flexibility to the document creator. Skilled website developers can create a scrollytelling type website by, for example, using a combination of HyperText Markup Language (HTML) and JavaScript. The creation of effective scrollytelling type websites can, however, prove difficult or even out of reach for less technical users.

There remains a need for alternative systems and methods for creating, generating or editing dynamic scrollable documents and to systems and methods for displaying dynamic scrollable documents.

Background information described in this specification is background information known to the inventors. Reference to this information as background information is not an acknowledgment or suggestion that this background information is prior art or is common general knowledge to a person of ordinary skill in the art.

### SUMMARY

Described herein are examples of computer implemented methods relating to generating dynamic scrollable documents. Time-varying content is mapped to scroll distance in a scrollable document. Techniques for optimizing the time-varying content are described. Page structures and page displays for the mapped content are described. Processes that support on-demand generation of the scrollable content, as well as editing workflows are described.

Examples of a computer implemented method include, by a computer processing system:
receiving, or retrieving from storage, first document content comprising time-varying content, the time-varying content comprising timing information defining one or more events or actions relating to the document content;
generating second document content based on the first document content, the second document content comprising scrollable document content with a scroll distance, wherein the scroll distance is determined by mapping the timing information to the scroll distance.

Examples of a computer implemented method include, by a computer processing system:
storing in data storage first document content comprising time-varying content, the time-varying content comprising timing information defining one or more events or actions relating to the document content;
receiving a request to display second document content, the second document content comprising mapped content, the mapped content comprising the time-varying content mapped to a scrollable document;
in response to receiving the request generating the mapped content.

Examples of a computer implemented method include, by a computer processing system:
mapping timing information associated with first document content to a first scroll distance;
generating a document comprising a container, wherein the container is a background element of the document and has the first scroll distance, and the document is configured to display the first document content, progressing through the first document content according to the mapping in response to scroll input through the container.

Examples of a computer implemented method include, by a computer processing system:
receiving, or retrieving from data storage, first document content comprising scrollable document content with a first scroll distance determined by the computer processing system; and
generating second document content comprising a container for the scrollable document content, wherein the second document content is configured to display the scrollable document content within the container;
wherein the first scroll distance is determined based on a distance that the container is in a viewport or display area or field of view of a display of the computer processing system.

Examples of a computer implemented method include, by a computer processing system:
receiving, or retrieving from storage, first document content comprising a) first time-varying content, the first time-varying content comprising first timing information defining one or more events or actions relating to the document content and b) one or more time periods associated with a static display of the first document content;
determining that the first document content comprises the one or more time periods associated with a static display of the first document content;
in response to the determining generating second document content based on the first document content, the second document content comprising second timing information, the second timing information differing from the first timing information by having at least one of the one or more time periods associated with a static display of the first document content reduced or removed.

Examples of a computer implemented method include, by a computer processing system:
receiving, or retrieving from storage, first document content comprising a) first time-varying content, the first time-varying content comprising first timing information defining one or more first events or first actions relating to the document content and b) one or more second events or second actions without associated timing information;
determining that the first document content comprises the one or more second events or second actions without associated timing information;
in response to the determining, generating second document content based on the first document content, the second document content comprising second timing information, the second timing information differing from the first timing information by defining timing information for at least one of the one or more second events or second actions without associated timing information.

Examples of a computer implemented method include, by a computer processing system:
receiving, or retrieving from storage, first document content comprising first scroll-varying content, the first scroll-varying content comprising one or more first animations comprising respective first extents of movement across a first display area having a first aspect ratio;
determining a second display area having a second aspect ratio, different to the first aspect ratio;
generating second document content based on the first document content and having the second display area, the second document content comprising second scroll-varying content, the second scroll-varying content comprising one or more second animations corresponding to the one or more first animations, the one or more second animations comprising respective second extents of movement across the second display area, wherein the respective second extents of movement are determined based on the second aspect ratio.

Examples of a computer implemented method include, by a computer processing system:
maintaining first document content comprising time-varying content, the time-varying content comprising timing information defining one or more events or actions relating to the document content;
causing the display, on a display, of second document content that is based on the first document content by a mapping process, the second document content comprising scrollable document content with a scroll distance, wherein the scroll distance is determined by mapping, as part of the mapping process, the timing information to the scroll distance;
receiving a request to edit the scrollable document content of the second document content;
in response to the request to edit the scrollable document content of the second document content, opening the first document content for editing;
receiving one or more requests to edit to the first document content and in response generating edited first document content;
generating third document content by performing the mapping process on the edited first document content; and
causing the display, on the display, of the third document content, wherein the third document content replaces the second document content.

Other examples will become apparent from the following description, given by way of example with reference to the accompanying figures.

### BRIEF DESCRIPTION OF THE DRAWINGS

FIG. 1 is a diagram depicting a networked environment.

FIG. 2 is a block diagram of a computer processing system.

FIG. 3 is a flowchart of a computer-implemented method for modifying original content.

FIG. 4 is a diagrammatic representation of original content and modified content.

FIG. 5 is a flowchart of a computer-implemented method for mapping content and for forming a dynamic scrollable document.

FIG. 6A to FIG. 6C show example screen displays of a user interface operated by a user to perform an editing operation of adding content to a document.

FIG. 7A to FIG. 7C show diagrammatic representations of a dynamic scrollable document and its playback and FIG. 7D shows an example screen display displaying the dynamic scrollable document.

FIG. 8A to FIG. 8C show example screen displays displaying a dynamic scrollable document.

FIG. 9 is a flowchart of a computer-implemented method for modifying scrollable content to suit a viewport for the scrollable content with a different aspect ratio.

FIG. 10 shows an example of scrollable content with a square aspect ratio that is to be displayed in a viewport having a rectangular aspect ratio.

FIG. 11 shows an example screen display of a user interface for a user to perform an editing operation of mapped content that has been added to a document.

The figures are provided for the purposes of illustration and explanation and are not shown to scale.

In some examples one or more, up to all the computer-implemented methods are provided together in a single application or group of applications. In some examples one or more, up to all the computer-implemented methods are provided as software as a service. Where options are described one or more, up to all the options may be available in the application, group of applications or software as a service. Any of these computer-implemented methods or combinations of computer implemented methods may further include processes described with reference to the user interface and screen shots in the accompanying figures. Further, one more of the processes described with reference to the user interface and screen shots in the accompanying figures may be provided separately from the computer-implemented methods shown in the figures.

Specific examples are shown by way of example in the drawings and are described in detail. It should be understood, however, that the drawings and detailed description are not intended to limit the invention to the particular form disclosed.

### DETAILED DESCRIPTION OF THE EMBODIMENTS

In the following description numerous specific details are set forth in order to provide a thorough understanding of the present invention. It will be apparent, however, that the present invention may be practiced without these specific details. In some instances, well-known structures and devices are shown in block diagram form to avoid unnecessary obscuring.

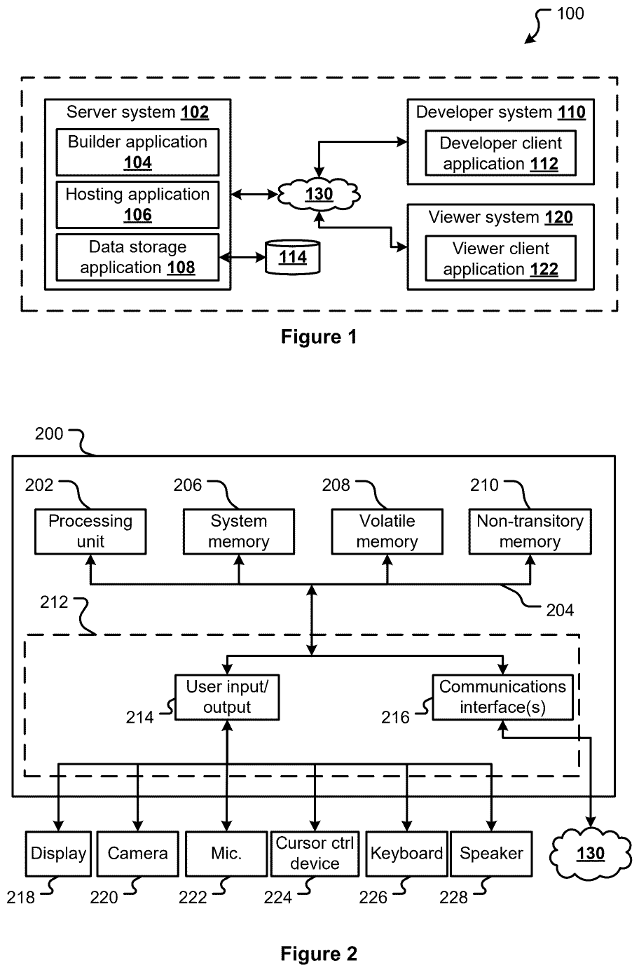

The processes described herein may be performed in a computing environment, for example a networked environment or a standalone computer processing system. FIG. 1 is a diagram depicting an example networked environment 100 configurable to implement examples and/or features described herein. FIG. 2 a diagram of an example computer processing system 200 configurable to implement examples and/or features described herein. A form of computer processing system, like that shown in FIG. 2, may form the components of FIG. 1 or may form the basis of a standalone computer processing system. It will be understood that the processes described herein may be performed in other computing environments.

Referring to FIG. 1 a networked environment 100 includes a server system 102 and two client systems, referred to as the developer system 110 and viewer system 120 with reference to the activities described herein that are performed on each client system. This is not intended to be limiting. For example a given client system may operate to perform functions of the developer system 110, the viewer system 120 or both. The server system 102 includes three applications, a builder application 104, a hosting application 106 and a data storage application 108. The developer system 110 includes a developer client application 112 and the viewer system 120 includes a viewer client application 122. These systems communicate via one or more communications networks 130, for example via the Internet. The networked environment also includes data storage 114, accessible by the server system 102 under the control of the data storage application 108.

The server system 102, developer system 110 and viewer system 120 each include computer processing hardware on which their respective applications execute to provide server-side functionality or client-side functionality. The builder application 104 and the hosting application 106 execute to provide client application endpoints accessible over communications network 130. For example, the builder application 104 or the hosting application 106 serve web browser client applications and, accordingly, are web server applications which receive and respond to HTTP requests. The developer client application 112 and viewer client application 122 may be web browsers. In alternative examples, the builder application 104 or hosting application 106 may serve a native client application (e.g. developer application 112 or viewer client application 122), in which case it will be an application server configured to receive, process, and respond to specifically defined API calls received from such a client application.

In the present example, the builder application 104 facilitates various functions related to creating dynamic scrollable documents. The hosting application 106 facilitates various functions related to displaying dynamic scrollable documents, for example by hosting dynamic scrollable webpages. Data defining the dynamic scrollable documents is stored in data storage 114. The data storage 114 may include one or more non-transitory computer readable storage devices such as hard disks, solid state drives, tape drives, or alternative computer readable storage devices. The data storage application 108 executes to receive and process requests to persistently store and retrieve data relevant to the operations performed/services provided by the server system 102. Such requests may be received from the builder application 104, the hosting application 106, and/or other server system applications. In other examples the data storage application 108 is omitted and the builder application 104, hosting application 106 or another application handles read/write operations to the data storage 114.

The developer client application 112 and the viewer client applications 122 are executed by their respective systems to configure those systems to provide client-side functionality to applications of the server system 102. Via the client systems and applications users can access the various techniques described herein and can provide user input.

FIG. 2 shows, in block diagram form, a computer processing system 200 configurable to implement examples and/or features described herein, together with some example peripherals. System 200 is a general-purpose computer processing system. It will be appreciated that FIG. 2 does not illustrate all functional or physical components of a computer processing system. For example, no power supply or power supply interface has been depicted, however system 200 will either carry a power supply or be configured for connection to a power supply (or both). It will also be appreciated that different types of computer processing systems may have different hardware and architectures than the hardware and architecture that is depicted and described in the present example.

Computer processing system 200 includes at least one processing unit 202. The processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable by system 200.

Through a communications bus 204 the processing unit 202 is in data communication with one or more machine readable storage (memory) devices, which store computer readable instructions and/or data executed by the processing unit 202 to control operation of the processing system 200. In this example system 200 includes a system memory 206 (e.g. a BIOS), volatile memory 208 (e.g. random access memory such as one or more DRAM modules), and non-transitory memory 210 (e.g. one or more hard disk or solid state drives).

System 200 also includes one or more interfaces, indicated generally by 212, via which system 200 interfaces with various devices and/or networks. Generally speaking, other devices may be integral with system 200, or may be separate. Where a device is separate from system 200, the connection between the device and system 200 may be via wired or wireless hardware and communication protocols, and may be a direct or an indirect (e.g. networked) connection.

By way of example, where system 200 is a personal computing device such as a desktop or laptop device, it may include a display 218 (which may be a touch screen display and as such operate as both an input and output device), a camera device 220, a microphone device 222 (which may be integrated with the camera device), a cursor control device 224 (e.g. a mouse, trackpad, or other cursor control device), a keyboard 226, and a speaker device 228. In another example, where system 200 is a portable personal computing device such as a smart phone or tablet it may include a touchscreen display 218, a camera device 220, a microphone device 222, and a speaker device 228.

As another example, where system 200 is a server computing device it may be remotely operable from another computing device via a communication network. Such a server may not itself need/require further peripherals such as a display, keyboard, cursor control device etc, though it may nonetheless be connectable to such devices via appropriate ports.

System 200 also includes one or more communications interfaces 216 for communication with a network, such as network 130 of environment 100. Via the communications interface(s) 216, the system 200 can communicate data to and receive data from networked systems and/or devices.

System 200 stores or has access to computer applications (which may also be referred to as computer software or computer programs). Generally speaking, such applications include computer readable instructions and data which, when executed by the processing unit 202, configure system 200 to receive, process, and output data. Instructions and data can be stored on non-transitory machine readable medium such as non-transitory memory 210 accessible to system 200. Instructions and data may be transmitted to/received by system 200 via a data signal in a transmission channel enabled (for example) by a wired or wireless network connection over an interface such as communications interface 216.

Typically, one application accessible to system 200 will be an operating system application. In addition, system 200 will store or have access to applications which, when executed by the processing unit 202, configure system 200 to perform various computer-implemented processing operations described herein. For example, and referring to the networked environment of FIG. 1 above, server system 102 includes one or more systems which run a builder application 104, a hosting application 106, and a data storage application 108. Similarly, developer client system 110 runs a developer client application 112 and viewer client system 120 runs a viewer client application 122.

In some cases, part or all of a given computer-implemented method will be performed by system 200 itself, while in other cases processing may be performed by other devices in data communication with system 200.

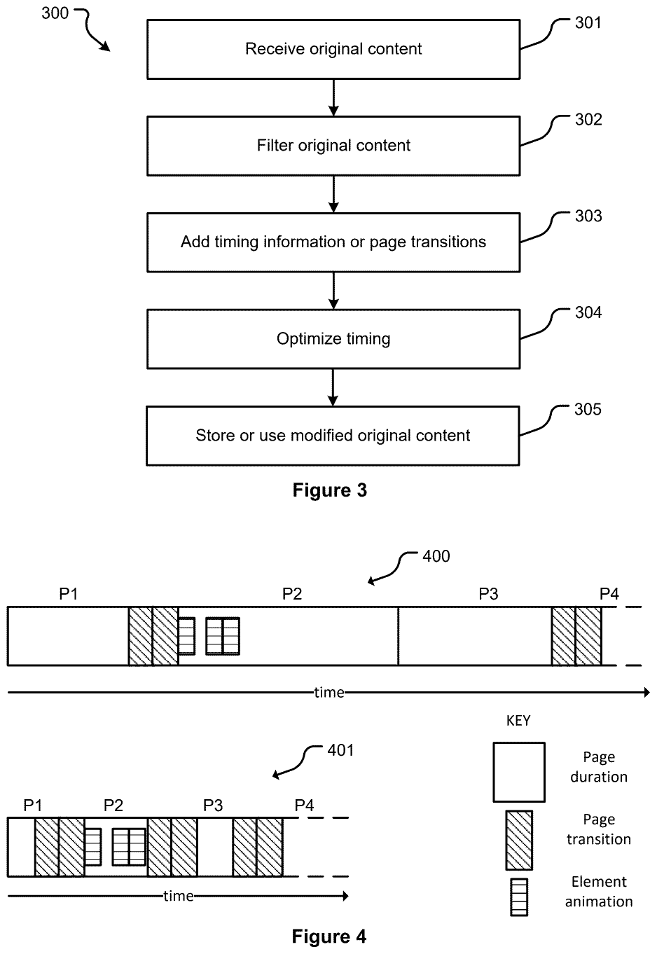

Turning to FIG. 3, a computer-implemented method 300 for modifying original content is shown. The method 300 is performed by a computer processing system executing or running computer readable instructions. For example, the method 300 may be performed by the system 200 or by the server system 102 in conjunction with the developer system 110 or the viewer system 120, or by another computer processing system. The method 300 may be performed as a precursor to transformation of the content in the original content into dynamic content for a dynamic scrollable document.

At step 301, original content for modification is received. The original content may have been produced using developer application 112 and the services provided by the builder application 104, or it may have been produced by another application that may or may not form part of the computer processing system that performs the method 300. The original content is readable by the computer processing system and may be in the form of data that defines a document or at least defines content for a document.

The original content includes timing information that defines one or more events or actions relating to the document, or if the document is determined not to include any timing information, the method 300 adds timing information in step 303 (see below). The timing information may form part of a data file defining other aspects of the original content or may be defined by other data, for example metadata, associated with a data file defining the other aspects of the original content. In other words, the original content may be formed by one data file or a plurality of data files.

The one or more events or actions defined by the timing information relate to at least one part or element of the document. In other words, the original content includes time-varying content. Example parts of elements of the document that the timing information relates to include page divisions (e.g. a timing for transition from page to another page), an animation (e.g. a start time, stop time or duration of an animation of an element), interactions with an element in the document (e.g. recorded user interactions with the element that affect what is displayed), sequential display of portions of a canvas with or without animated transitions and so forth.

In some examples the time-varying content is initiated by, or performed responsive to, an action or event. For example, a received user selection may be received that initiates the time-varying content. The user selection may be the selection of a button, such as a “Next” button in a presentation for a presentation document. In another example the time-varying content may be initiated by a timing trigger, for example the expiration of a timer or reaching of a time after a preceding action or event.

In some examples the original content is a presentation document. In some examples the original content is a recording of a presentation document, or other data defining the presentation of a presentation document. The original content may include an embedded video and timing information for the document may include a timeline of or associated with the video. In some examples the original content is in the form of a video file. In some examples the original content is a three-dimensional (3-D) rendering, which may include movement or transitions over time, such as rotation to view 3-D object(s) in the rendering from different perspectives, zooming in or out, panning across different regions of a scene, or transitioning between predefined camera paths or perspectives.

In some examples the original content is filtered in step 302. The computer processing system determines and removes (i.e. filters) content from the original content that is determined to be incompatible or with, or otherwise determined to be excluded from, transformation to a scroll-based animation. In one example scroll-based animations in the original content are removed.

In some examples the method 300 includes, in step 303, adding time information or page transitions to the received original content. For example, the added time information may be added to a data file of the received original content or may be added to a new data file associated with the data file(s) defining the received original content. In some examples step 303 includes determining that the time information in the original content is incomplete and in response adding timing information to the original content.

Received original content may be determined by the computer processing system to have one or more animations without timing information indicating when to perform the animation(s), for example because it is dependent on a user action. Timing information is then added to initiate the animation(s). For example an animation or a first in a series of animations, may be set to initiate on the entry page transition for the page in which the animation appears, or after a set period of time following the display of the page. Any subsequent animations may similarly occur immediately following the first animation or after a short delay.

Received original content may be determined by the computer processing system to have two or more pages without timing information indicating when to transition between the pages. Timing information is then added by the computer processing system that sets a time for transition between each page. The time for a transition may be set based on the duration of any time-varying content that is in the document. For example, if a page includes one or more animations, the start time of the first animation and end time of the last animation may be determined, and the time interval for transition for the page set to encompass or contain all the animations. Additional time at the beginning and end may be added to avoid immediate page transitions on completion of an animation. In examples in which page transition animations are added (see below), this additional time may correspond to the time required for the page transition animation. In one example the time intervals for one or more pages, up to all the pages, is set based on or set to be equal to a sum of a maximum duration of completion of time-based events in a single page, including any page transitions (added or not). One or more pages may be set to have a predetermined time interval, for example 20 seconds or 30 seconds or another time interval, which need not be an integer number of seconds. Application of the predetermined time interval may be subject to the page not including time-based events that exceed the time interval, in which case the time interval may be extended as required to accommodate all the time-based events.

In some examples step 303 includes adding page transition animations for adjacent pages without a transition animation or with only a partial transition (e.g. an exit transition for one page but no entry transition for the next page). The page transition animations may include one or both of an exit transition for the current page and an entry transition for the next page. The completion time for a page transition from one page to the next has a non-zero value. For example, the time duration may be at least 0.5 seconds or at least 1 second. Shorter or longer transitions may be used for one or more of the page transitions.

Step 304 includes determining that the original content includes one or more periods of time in which there is no time-varying content or in which there is a static display. In response to the determination, these periods of time are reduced. For example, if the screen was static for more than a threshold time, then the duration while the screen is static is reduced to the threshold time or another time, which may be a similar time to the threshold time. The threshold time or reduced time may be a system parameter or a user configurable parameter. An example threshold time is ten seconds. Other threshold times may be used, which need not be an integer number of seconds.

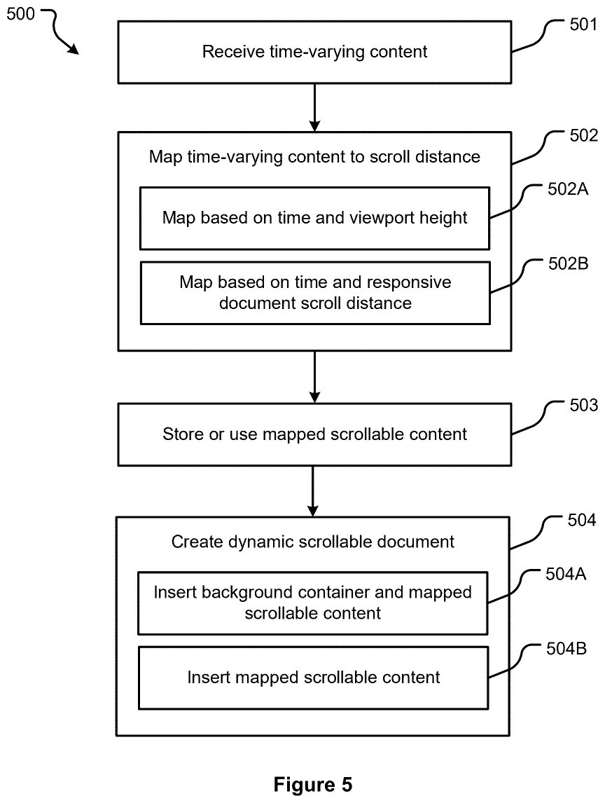

Step 305 includes storing or using the modified original content. The modified content may be stored, for example in data storage 114, ready for further processing. The modified content may be immediately further processed and if so, it is optionally stored in only transitory storage accessible to the computer processing system performing the further processing. In either case, the further processing may include the method 500 described herein with reference to FIG. 5.

The method 300 for modifying original content includes steps 301 and 305, and one or more of steps 302 to 304, in whole or in part. Step 303 may be omitted in part or entirely; the method may omit adding timing information or adding page transitions. The omission of step 303, or of steps 302 or 304 may be consequent on or responsive to a determination based on the received original content that these processes are not required. The omission of these steps may instead be for all received original content, e.g. the computer processing system may not be configured with instructions to perform one or more of steps 302 to 304 in whole or in part. In some examples the inclusion or omission of a process in steps 302 to 304 is based on a user preference setting or otherwise. Further, it will be understood that further modification processes may be performed, for example to transcode original content from one format into another format, compressing or decompressing the content, and so forth.

FIG. 4 shows a diagrammatic representation of original content that may be received in step 301 and modified content that may be generated by the method 300. Specifically, the representation of the original content is in the form of an original content timeline 400 and the representation of the modified content is in the form of a modified timeline 401. The content of both the original content and the modified content includes pages, page transitions and element animations. Each of these have a non-zero duration that is represented in the timelines 400, 401.

Three full pages and one partial page is represented in FIG. 4 and these are indicated as P1, P2, P3 and P4. The dashed lines at the right edge of the timeline indicate that the original content may include any number of pages. The pages are displayed in sequence.

The original content includes an exit page transition for pages P1 and P3, and an entry page transition for pages P2 and P4. Page P2 includes three element animations. In the example shown the page transitions and element animations each have the same duration, but this is not necessary. Further the page transitions may be the same as each other or differ and the element animations may similarly be the same or different.

The modified content includes the exit page transitions for pages P1 and P3, the entry page transitions for pages P2 and P4. The modified content also includes an exit page transition for page P2 and an entry page transition for page P3. These have been added, for example as part of step 303 of the method 300.

The modified content includes pages P1 to P3, but each has a shorter duration than in the original content, indicated by their shorter spans along the timeline. The shortened duration may be determined as part of step 304 of the method 300. Each page may have a minimum duration in the modified content. The minimum duration may be set with reference to the mapping to scrolling, so that a user performing scrolling can still easily perform navigation, such as pausing scrolling when a page is fully transitioned in. Each page without element animations may be set to the same duration, which may be the minimum duration.

The modified content retains the three element animations in page P2. In some examples the duration of the element elements is retained in the modified content. As can be seen from FIG. 4 the duration of Page P2 is sufficient to accommodate the element animations, and that duration is longer than other pages that have no time-varying content or pages time-varying content of lesser duration (none shown in FIG. 4). Similarly, in some examples the duration of other time-variable elements in the original content is retained in the modified content. In other words, the optimization of the original content serves to reduce or remove periods of time in which there is no time-variation or in which nothing is happening or in which the display is static. Relatively short periods without time-variation, e.g. time periods less than the minimum duration for a page in the modified content or durations less than another threshold value, may be retained. An example is the short period between the first and second element animations in FIG. 4.

FIG. 5 shows a method 500 of forming a dynamic scrollable document. The method 500 is performed by a computer processing system executing or running computer readable instructions. For example, the method 500 may be performed by the system 200 or by the server system 102 in conjunction with the developer system 110 or the viewer system 120, or by another computer processing system. The method 500 may be performed, for example, following the completion of the method 300 as described herein with reference to FIG. 3 or FIG. 4.

In step 501 time-varying content is received. Time-varying content is described herein with reference to the method 300 of FIG. 3 or with reference to FIG. 4. The time-varying content may be original content or may be modified original content, for example produced by the method 300 or by another method. The time-varying content may have been created by the computer processing system performing the method 500 or created by another system and received by the computer processing system performing the method 500.

In step 502 the computer processing system maps the time-varying content to scroll distance to create mapped content. The mapped content may for example be a scrollable document or other scrollable content be insertable into a responsive document.

By mapping the time-varying content to scroll distance, the display of the dynamic scrollable document is controllable through a scroll input, with each scroll position resulting in the display of content that would have been displayed at a certain point of time in the time-varying content. Whilst the time-varying content may transition from one state (e.g. page) to the next (e.g. by clicking on a “next” button in a presentation at a certain point in time), and the transition between them may play through to completion without the ability to be stopped or paused, the dynamic scrollable document is different in the way it is viewed or consumed. In a dynamic scrollable document, the whole item is treated more similarly to a video that can be scrubbed through. Using scroll input the user can move through the timings at their own speed-pausing and continuing at any point and whenever they want and even going backwards. In other words, the whole dynamic scrollable document is or is associated with a continuous timeline that is directly linked with the scroll position in the document.

Referring to the networked environment 100, the display of a dynamic scrollable document may be controlled by the viewer client application 122 and the hosting application 106. For example, the dynamic scrollable document may be in the form of a published web page stored in data storage 114, under the control of the data storage application 108. The hosting application 106 may be a web server and the viewer client application 122 a web browser. During development of a dynamic scrollable document or content thereof, the display of the dynamic scrollable document may be controlled by the developer client application 112 and the builder application 104. The development of and publication or consumption of a dynamic scrollable document may be, but need not be in the same data format; development may be in one data format, and the developed document converted into another data format for publication.

In some examples the mapping of step 502 is directly related to time information in the time-varying content or based only on the time information and no other variable. From the received time-varying content, t seconds of time indicated by the time information may be mapped to m pixels of scroll distance. To illustrate, a duration of one second may be mapped to 250 pixels; time-varying content with a total duration of five seconds is then mapped to 1000 pixels of scroll distance. The number of pixels that each unit of time is mapped to may be fixed or may be variable, for example a configurable parameter. Whilst seconds and pixels are anticipated to be an appropriate and convenient measure of distance and time respectively, other measures may be used.

In some examples the mapping is linear. In other examples one or more non-linear mappings may be utilised for all or part of the time information, to achieve various user-interaction effects. The mapping may be determined by the computer processing system or determined externally of the computer processing system and received by the computer processing system.

In other examples, the scroll distance in pixels is based on both time and a viewport height. These examples are represented in FIG. 5 by step 502A. A viewport is an area rendered (or to be rendered) on a display device, within which the mapped scrollable content is (or is to be) displayed or viewed. In the context of a web page, a browser provides a viewport for viewing a document, in this case the mapped scrollable content. An application other than a browser may also provide a viewport. In some examples a required viewport height is first determined, set or received by the computer processing system, and the scroll distance determined based on the required viewport height and time information from the time-varying content, for example a total duration of the time-varying content.

The viewport height may be fixed, or it may be a variable determined or received by the computer processing system for determining the scroll distance. Determination of a viewport height depends on several variables, including the window size, screen size and zoon level. The viewport height may differ depending on whether the relevant display is in portrait or landscape orientation. The viewport height for a smartphone or tablet may be different to the viewport height for a desktop computer. The determination of the viewport height may therefore be based on one or more of these variables. The viewport may be independent of the mapped scrollable content. The viewport height may not be specified by the data defining the mapped scrollable content.

The viewport height may cover the entirety of a display screen or may cover only part of a display screen. The view width may similarly cover the entirety of the display screen or only a part thereof. The description of the examples herein use “height” to refer to vertical distance on a display screen, which is a common direction for scrolling. However, scrolling in a horizontal direction is also possible, in which case references to “height” can be replaced with references to “width”.

In some examples a total scroll distance to consume or view the mapped scrollable content is based on, related to or proportional to both the viewport height and the total duration of the time-varying content. The total scroll distance may be determined as the product of a scroll rate, the viewport height and the total duration of the time-varying content. The scroll rate may be a constant and is a measure of the scroll distance per unit time, relative to the viewport height. To illustrate, a scroll rate of 0.5 per second or 50% means that a scroll distance equal to 50% of the viewport height maps to one second in the time-varying content. A scroll rate of 1.0 per second or 100% means that a scroll distance equal to 100% of the viewport height maps to one second in the time-varying content.

For example, if:
a) the time-varying content has 3 pages, with the first two pages each having associated time information covering a duration of 1.5 seconds and the third page having time information covering a duration of 2 seconds;
b) the scroll rate is set to 50%; and
c) the viewport height is set or determined to be 1000 pixels;
   then the total scroll distance is the product of 5 seconds, 0.5 per second and 1000 pixels, which is 2500 pixels.

In other examples the scroll distance in pixels for the mapped scrollable content is determined based on time and a scroll distance through a responsive document in which the mapped scrollable content appears. These examples are represented in FIG. 5 by step 502B. The responsive document is a scrollable document in the static or non-dynamic sense. The scroll distance to progress through the mapped scrollable content may relate to or be equal to the scroll distance required to move a container for the mapped scrollable content through a viewport, field of view or display area. A user scroll input will therefore serve two purposes, one being to move the mapped scrollable content into, through and out of the field of view and the other to progress through the mapped scrollable content whilst it is in the viewport, field of view or display area.

In one example, the scroll distance may be the distance between when the container or mapped scrollable content is first fully displayed in the viewport, field of view or display area and when the container or mapped scrollable content first reaches the edge of the viewport, field of view or display area. This example may be used in an implementation in which progression through the entirety of the mapped scrollable content corresponds to the scroll distance while the mapped scrollable content is fully within the field of view. If the mapped scrollable content or the container for it is 250 pixels high and the viewport, field of view or display area is 1000 pixels in total, then the scroll distance may be 1000-250 or 750 pixels.

In step 503 the mapped scrollable content determined in step 502 is stored in storage, for example the data storage 114 for future use, or used for immediate further processing. In either case the future use or further processing may be step 504 of the method 500 described below. In some examples the time-varying content on which the mapped scrollable content is based or from which the mapped scrollable content was generated is also stored in storage, for example the data storage 114, and the mapped scrollable content and the time-varying content associated with each other.

Steps 501 to 503 may be viewed as a method for creating scrollable content based on time-varying content and the process may end at step 503 (i.e. not continue to step 504 of the method 500) if that is all that is required, at least at the time of execution of the method 500. For example, the mapped scrollable content from steps 501 to 503 may define or be used to define a dynamic scrollable document which is substantially entirely the mapped scrollable content. In another example, steps 501 to 503 are performed to create document assets in the form of mapped scrollable content, the document assets being usable in the creation of other documents, particularly where there is a known and fixed viewport height.

In other examples the mapped scrollable content is included in or embedded within another scrollable document, called herein a responsive document. For example, the mapped scrollable content may be inserted or insertable into a responsive document as an editing operation of the responsive document. Depending on the mode of inclusion or embedding, when the responsive document is viewed, from the perspective of the user a scroll operation either sequentially scrolls the responsive document and the dynamic scrollable document or simultaneously scrolls the response document and dynamic scrollable document. An example of both modes is provided below. Other methods of display of a mapped scrollable content in a responsive document may be used.

In step 504 a dynamic scrollable document is created using the mapped scrollable content from step 503. In some examples a container is inserted into the responsive document. These examples are represented in FIG. 5 by step 504A. The container may have an associated container scroll length. The container scroll length may be determined as described above with reference to step 502A. The container extends the responsive document invisibly in the background to allow sufficient “scroll space” to consume the mapped scrollable content by scrolling through the mapped scrollable content. The relevant document file may also include other containers.

The mapped scrollable content may be displayed in the viewport (also referred to as a field of view or display area) in its initial state (i.e. before progressing based on scrolling) until the dynamic scrollable document is scrolled to a particular position in the viewport. To illustrate, the viewport may be initially located to view material above the container. Responsive to a received user scrolling request, the container enters the viewport (or equivalently the viewport moves to the container, depending on perspective). When the viewport is in a particular location, continued user scrolling requests cause the container to scroll in the background and the viewport displays in the foreground progression of the mapped scrollable content. That location may be the top of the container reaching the top of the viewport. The continued user scrolling requests cause the mapped scrollable content to progress until the end of the mapped scrollable content is reached. At that time the viewport is at the end of the container. Still further user scrolling requests cause the container to scroll out of the field of view and the mapped scrollable content continues to display its final display state as the container is scrolled off the screen. The display shows the mapped scrollable content, in its final state, scrolling out of the viewport in the normal manner for static scrollable content.

The process of step 504A is analogous to the HTML/CSS example, inserting a container with a height of 2500 pixels and a “sticky”<div> that remains in place when the user scrolls the page, until the user scrolls past the 2500-pixel container:

```
<div class=‘canvas’>
  <div class=‘body’>
  <div class=‘content’>
    <p>Some text content in the doc.</p>
    <!-- Sticky scroll container’ -->
    <div style=‘position: relative; height: 2500px;’>
    <!-- Sticky design item’ -->
    <div style=‘top: 0; height: 1000px; position: sticky;’>
    </div>
    </div>
    <p>More text content in the doc.</p>
  </div>
  </div>
</div>
```

In other examples the mapped scrollable content is inserted into the responsive document without an extended background container. These examples are represented in FIG. 5 by step 504B. The mapped scrollable content may be in a container of the document.

For example, the mapped scrollable content is displayed in the responsive document in the same manner as other objects in the responsive document. User scroll input causes the viewport position to change, so that the mapped scrollable content scrolls into the viewport, across the viewport and then exits the viewport. During this time the user scroll input also causes the mapped scrollable content to progress. The mapping of scroll distance to progression of the mapped scrollable content may be as described with reference to step 502B. The mapped scrollable content may progress through entirely whilst it is scrolled across the viewport. For scrolling of content that moves upwards (or equivalently for scrolling of the field of view downwards), the progression of the mapped scrollable content may commence when the mapped scrollable content is scrolled fully into the viewport (i.e. the trailing edge of the dynamic scrollable document corresponds to or is just inside the viewport). The progression of the dynamic scrollable document may reach its end when the responsive document is scrolled to a point when the leading edge of the mapped scrollable content corresponds to or is just inside an upper edge of the viewport.

In some examples the computer system is configured to perform steps 502A and 504A of the method 500 and not steps 502B and 504B. In some examples the computer system is configured to perform steps 502B and 504B of the method 500 and not steps 502A and 504A. In some examples the computer system is configured to perform all steps 502A and 502B or steps 504A and 504B depending on other input or determinations, such as a user selection or a determination based on the duration of the time-varying content. Steps 502A and 504A may be suited to longer duration time-varying content and may be applied if the duration is determined to be above a threshold value. Steps 502B and 502B may be suited to shorter duration time-varying content and may be applied if the duration is determined to be at or below a threshold value.

It will be appreciated that in some examples the received time-varying content may be the source file for what is displayed by a computer processing system as a dynamic scrollable document, which system will perform a mapping to scroll distance. In other examples data or one or more files defining the mapped content itself (i.e. including information that relates scroll input to content for display) may be the source file for what is displayed, in which case the mapping step is not required to be performed again.

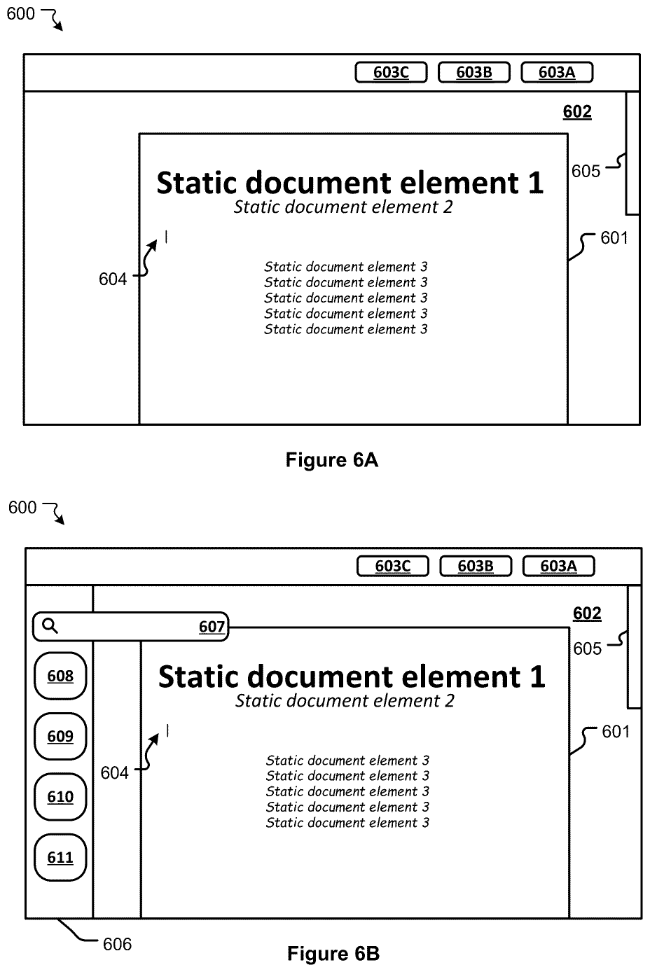

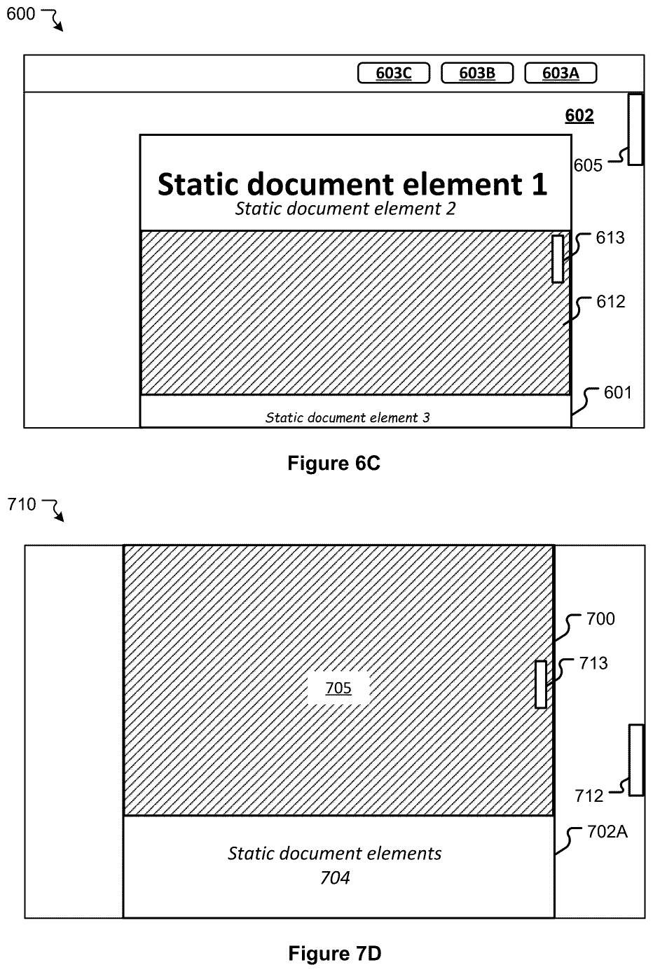

FIGS. 6A to 6C show example screen displays of a user interface (UI) 600 operated by a user to perform an editing operation of adding content to a document 601, which is a static scrollable document before the addition of mapped scrollable content, to create a dynamic scrollable document. The UI 600 is a user interface of a document editing application. The document editing application may for example be the developer client application 112, which may operate in conjunction with the builder application 104.

FIG. 6A shows an example screen display of the UI 600. The screen display includes a canvas 602 in which a document is displayable. In FIG. 6A an example document 601 is displayed on the canvas 602. The document 601 includes three document elements, static document elements 1 to 3. By way of illustrative example, static document element 1 may be an image element, static document element 2 a text heading element and static document element 3 a block of text. It will be understood that a document may include any of many types of document elements.

The editing application displays a cursor 604, performing the function of providing an indicator of a location for editing operations. The UI 600 includes a scroll bar 605, indicating a scroll position in the document. In some examples the scroll bar 605 is also functional, allowing a user to scroll through the document, for example by dragging the scroll bar, selecting a location to move the scroll bar, or selecting other indicia (not shown) associated with the scroll bar or with the scrolling operation.

The editing application also displays selectable indicia in a tool bar above the canvas 602. In this example the selectable indicia are selectable buttons 603A, 603B and 603C, for performing editing operations. The selectable indicia may be located elsewhere in the screen display of the UI 600, including in a toolbar at another location, on the canvas 602 or on the document 601, such as adjacent the cursor 604. Selection of at least one of the selectable indicia causes the editing application to initiate a process for adding or inserting content to the document to create a dynamic scrollable document.

FIG. 6B shows another example screen display of the UI 600. The screen display of FIG. 6B is displayed responsive to selection of a selectable button in the screen display of FIG. 6A (e.g. selectable button 603A) to initiate the process for adding or inserting mapped scrollable content to the document to create a dynamic scrollable document. In addition to the part of the UI described with reference to FIG. 6A, the screen display includes a content selector 606. The content selector 606 includes a search field 607 for searching for insertable content, for example by file name. The content selector 606 also includes representations of content insertable into the document 601 and in this example four insertable content representations 608, 609, 610 and 611 are shown. The insertable content may be, but need not be, exclusively mapped scrollable content. In other words, the insertion functionality may be specific to creating a dynamic scrollable document or a general insert function for a range of different types of document elements, including document elements that result in a dynamic scrollable document.

The representations of the insertable content may have been shown in response to a search using the search field 607. The content selector 606 may be presented on the display in any suitable manner. In the example shown the content selector 606 is displayed simultaneously with the document 601, including with the cursor 604. This enables the user to maintain visibility of where content is to be inserted into the document 601. However, this is not essential, and other display options may be used.

FIG. 6C shows another example screen display of the UI 600. The screen display of FIG. 6C is displayed responsive to selection of insertable content 612 to insert into the document 601 from the screen display of FIG. 6B (e.g. selection of insertable content representation 608). The insertable content 612 is time-varying content mapped to scrollable content (i.e. mapped scrollable content) and may have been created by any of the processes described with reference to FIG. 5. The time-varying content may have been generated using a process described with reference to FIG. 3 or FIG. 4.

Selection of the insertable content causes the editing application to insert that content into the document 601 and to display the updated document 601 with the insertable content 612 added. The existing content of the document 601 is moved as required to accommodate the insertable content 612 and in this example the static document element 3 now appears further down the document. The length of the document 601 is now increased and this may be reflected by the length of the scroll bar 605, which shortens responsive to the decreased proportion of the document 601 displayed. In some examples the content selector 606 is automatically (i.e. without further user input) ceased to be displayed in the UI following selection of content to insert.

The insertable content 612 is mapped scrollable content as described herein. The insertable content 612 may have been created by any of the processes described with reference to FIG. 5. In some examples the insertable content 612 is displayed with its own scroll bar 613. Accordingly, the UI 600 can display two scroll bars, one for the document 601, which is a responsive document receiving the insertable content 612, and one for the insertable content 612. In some examples the scroll bar 613 is indicative only and that scroll control is by the scroll bar 605. In other examples the scroll bar 613 is also functional to allow scrolling through the insertable content 612.

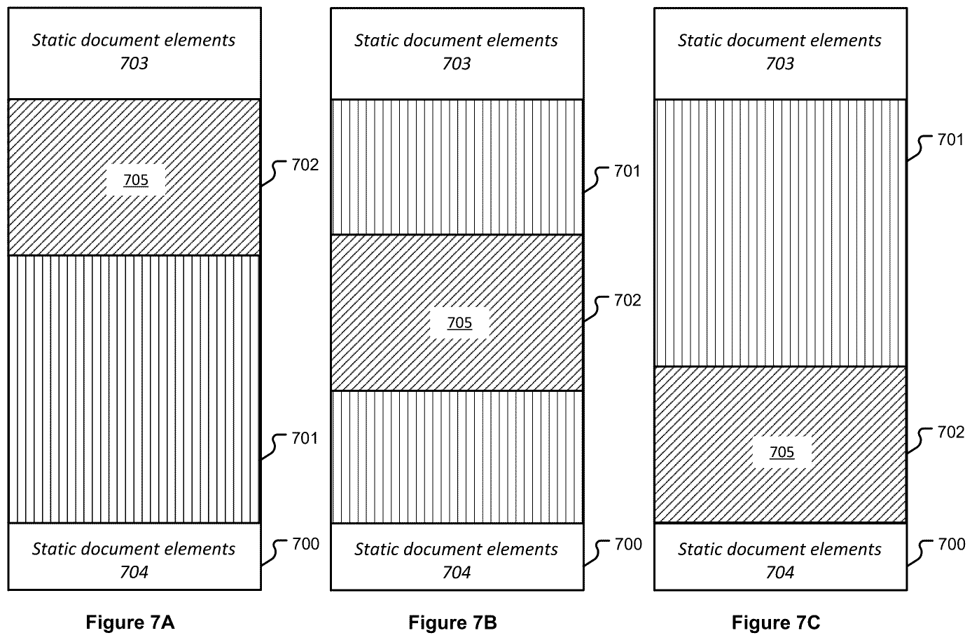

FIGS. 7A to 7C show diagrammatic representations of a dynamic scrollable document 700 and its display, consumption, viewing or playback. The dynamic scrollable document includes mapped scrollable content 705 created based on time-varying content, for example using the process of FIG. 5, including steps 502A and 504A. The time-varying content may have been generated using a process described with reference to FIG. 3 or FIG. 4.

The dynamic scrollable document includes a container 701 for the mapped scrollable content 705. Also shown in FIGS. 7A-C is a viewport 702, for example a viewport of a browser or other application showing the portion of the document 701 that is being displayed. In the example of FIGS. 7A to 7C the dynamic scrollable document 700 includes static documents elements 703 and 704, which have a scrollable height and scroll onto and off the page responsive to a scroll request. In other examples some or all the static document elements 703, 704 may be omitted.

The container 701 is a background of the document 700, whereas the static document elements 703, 704 and the mapped scrollable content 705 are foreground. The container 701 has a scrollable height in the document 700. As explained herein the height is based on the time duration of the time-varying content or based on the time duration of the time-varying content and the height of the viewport 702. Example calculations are described herein, including an example in which the viewport height is 1000 pixels and the container scroll height is 2500 pixels.

A user may commence with a viewport at the top of the document 700. In that case the user may view the entirety of the static document elements 703 and the top of the mapped scrollable content 705. At that scroll position, the mapped scrollable content 705 is displayed in an initial state, which may be viewed as a scroll position of zero. The initial state corresponds to the initial state or time=0 in the time-varying content used to create the mapped scrollable content 705. This scroll state is shown in FIG. 7A, which shows the viewport 702 at the top of the container 701 (or the container is at the top of the viewport).

In some examples scroll control of the mapped scrollable content 705 commences when the container 701 is at the top of the viewport 702. When the user scrolls beyond the location where the top of the container 701 is at the top of the viewport 702, the further scroll input controls the progression of the mapped scrollable content 705. The viewport 702 continues to display the mapped scrollable content 705 responsive to the user scrolling beyond this point. Accordingly, in this range the scroll input results in scrolling in the manner of a dynamic scrollable document. As described above, scroll input through a dynamic scrollable document when displaying mapped scrollable content is more akin to scrubbing through a video than scrolling through a document. If the time-variable content has a total duration of 5 seconds, the mapped content will display its final state corresponding to time=5 seconds when the user has scrolled to the position shown in FIG. 7C. When in the position shown in FIG. 7B the viewport 702 is at a mid-point of the container 701 and the mapped scrollable content 705 displays content corresponding to a time of about 2.5 seconds in the time-variable content.

When the user further scrolls beyond the scroll length of the container 701, or in other words the user scrolls further beyond the point represented by FIG. 7C, then the scroll input returns to “static” control and the dynamic scrollable document is progressively scrolled off out of the viewport. The static document elements 704 are moved into viewport and also scrolled across and off the viewport with continued scroll input.

Scrolling in the opposite direction results in static scrolling of elements downwards. The dynamic scrolling controls the progression of the mapped scrollable content 705 in the opposite direction, akin to going backwards in time or rewinding a video.

In FIG. 7A-C the aspect ratio of the mapped scrollable content 705 matches the aspect ratio of the viewport 702. The mapped scrollable content 705 may therefore fill the entirety of the viewport 702.

FIG. 7D shows an example screen display 710 displaying the document 700 in a viewport 702A with a different aspect ratio and without any adjustment in response, for example as described later herein. The screen display includes the viewport 702A displaying the mapped scrollable content 705 and the static document elements 704. As described above for the viewport 702, the viewport 702A is also “sticky”, so that the mapped scrollable content 705 remains at the top of the viewport whilst the mapped scrollable content 705 is scrolled. The screen display 710 corresponds to a scroll state indicated by FIG. 7B. This is indicated by a scroll bar 713 being positioned at a mid-point, indicating that the mapped content is at a mid-point. The display of the scroll bar 713 or other indicator of progress of the mapped content may be omitted in other examples. The screen display 710 also includes a scroll bar 712 for the document 700, showing where in the document 700 (including the scroll length of the container 701 in the background) the scroll control is at.

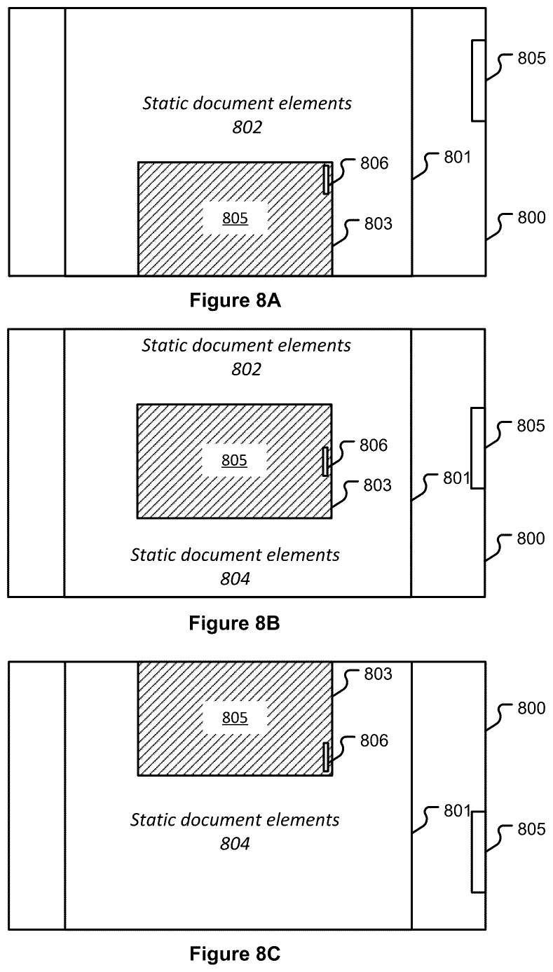

FIGS. 8A to 8C show diagrammatic representations of a screen display 800 during viewing, consumption or playback of a dynamic scrollable document 801. The dynamic scrollable document 801 includes mapped scrollable content 805 created based on time-varying content, for example using a process described with reference to FIG. 5, including steps 502B and 504B. The time-varying content may have been generated using a process described with reference to FIG. 3 or FIG. 4.

The dynamic scrollable document 801 includes a container 803 for the mapped scrollable content 805. The container 803 occupies a portion of the display area or viewport in at least the vertical direction.

In the example of FIGS. 8A to 8C the dynamic scrollable document 801 includes static documents elements 802 and 804, which have a scrollable height and scroll onto and off the page responsive to a scroll request. In other examples some or all the static document elements 802, 804 may be omitted.

A user may commence at the top of the document 801 and scroll downwards through the document 801, for example operating a functional scroll bar 805. The static document elements 802, 804 and the container 803 scroll responsive to the user scroll request. The mapped scrollable content 805 remains in an initial state, or a display state corresponding to time=0 in the time-varying content, when the container 803 is below the display area in whole or in part. The initial state is indicated in FIG. 8A by a scroll bar 806 being at the top of the container 803. Other indicators of progress of the mapped content may be used. The scroll bar 806 may be indicative only or functional. If functional, it will cause visible scrolling of the entire document 801 in the display area, just as scrolling through the document 801 causes progression of the mapped scrollable content 805. In other examples a scroll bar or other indicator of progression of the mapped content is omitted.

The location at which scroll control of the mapped scrollable content 805 commences is shown in FIG. 8A—the point at which the container 803 is first entirely within the display area. In other examples other locations may be used to achieve certain effects, such as progression of the mapped scrollable content 805 whilst the container 803 is scrolled into the display area or progression of the mapped content when the container 803 is higher in the display area.

Further scrolling controls the progression of the mapped scrollable content 805. In contrast to the example described with reference to FIGS. 7A-C and FIG. 7D, in which the mapped scrollable content remains in a fixed position in the viewport, in the example of FIGS. 8A-C the container 803 continues to scroll responsive to the scroll input and thus the location at which the mapped scrollable content 805 is displayed in the viewport changes simultaneously with progression of the mapped scrollable content 805.

When the document 801 is in the scroll position shown in FIG. 8B the container 803 is at about a mid-point of the display area (considered in the scroll direction, which is vertically in this example). The mapped scrollable content 805 displays content corresponding to a mid-point of time in the time-variable content and the position of the scroll bar 806 reflects this. When the document 801 is in the scroll position shown in FIG. 8C the container 803 is at an upper edge of the display area, the mapped scrollable content 805 displays content corresponding to the end of the time-variable content and the position of the scroll bar 806 is at the end of its range. In other examples the scroll position of the container 803 corresponding to the end of the time-variable content may be different to achieve different effects. For example, the scroll position of the container 803 corresponding to the end of the time-variable content may be when the lower edge of the container 803 corresponds to the upper edge of the display area, or in another location.

When the user further scrolls beyond the point represented by FIG. 8C, then the scroll input returns to “static” control and the container 803 is progressively scrolled off of the display area, with the mapped scrollable content 805 remaining in its final state. The static document elements 804 are moved upwards in the display area and scrolled off the display area with continued scroll input.

Scrolling in the opposite direction results in static scrolling of elements downwards in the scroll area. The dynamic scrolling controls the progression of the mapped scrollable content 805 in the opposite direction, akin to going backwards in time or rewinding a video.

In some examples the mapped scrollable content is displayed in a display area that has the same aspect ratio as the mapped content. In other examples the aspect ratios do not match, for example as shown in FIG. 7D. In some examples it may be required to display the mapped content across the entirety of the viewport, even though the aspect ratios do not match.

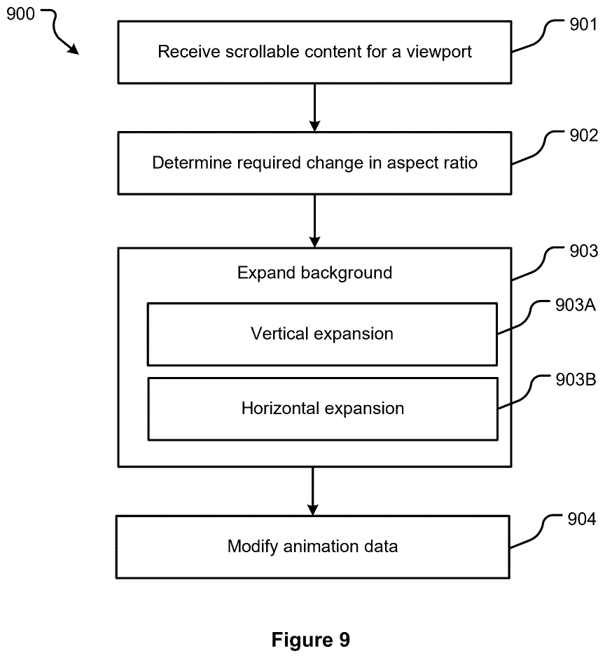

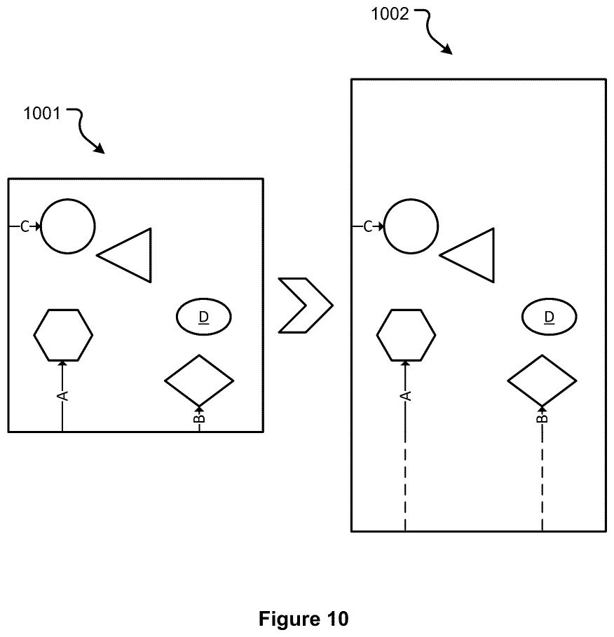

FIG. 9 shows a method 900 of modifying mapped scrollable content to suit a viewport (e.g. if the scrollable content is to cover the entire viewport) or a user's visible container for the scrollable content with a different aspect ratio. The method 900 is performed by a computer processing system executing or running computer readable instructions. For example, the method 500 may be performed by the system 200, by the server system 102, by the developer system 110, by the viewer system 120 or by another computer processing system. The method 500 may be performed, for example, as part of step 504 of the method 500 as described herein with reference to FIG. 5. In some examples the method is performed dynamically, based on the user's viewport or visible container at the time of consumption of the scrollable content. For example, the method 900 may be performed before the scrollable content is displayed and again if the user's viewport or visible container changes whilst the scrollable content is being displayed.

In step 901 scrollable content for the viewport or visible container is received. The scrollable content may be, for example, the mapped scrollable content described herein. The scrollable content includes one or more animations, such as elements that move or change responsive to user scroll input.

In step 902 the computer processing system determines a required change in the aspect ratio. A change may be determined as required whenever the aspect ratio of the scrollable content is different to the aspect ratio of the viewport or visible container. Step 902 includes determining the extent of change required to the scrollable content so that its aspect ratio matches that of the viewport or visible container. The scrollable content may require vertical expansion or alternatively horizontal expansion.

In step 903 a background of the scrollable content is expanded vertically (step 903A) or horizontally (step 903B) by an extent determined in step 902. The relative positioning of content in the scrollable content is retained. In some examples the expansion is in both directions; that is for vertical expansion the background is extended both upwards and downwards and for horizontal expansion the background is extended both left and right. The expansion in each of the two directions may be equal, so that a center point of the scrollable content remains the same relative to the content in the scrollable content.

In some examples the method includes step 904 of modifying animation data in the scrollable content. Animations that have as a reference location or which are relative to an edge of the scrollable content that has been expanded are modified to add a distance corresponding to the extent of expansion of that edge due to the expansion of the background in step 903. For example, if horizontal expansion (step 903B) is performed in step 903, then step 904 includes determining any animation that involves a document element moving in from the left or right edges and increasing the extent of movement by an amount corresponding to the adjustment of relative location of the left or right edges to the end location of the animation.

FIG. 10 shows an example of scrollable content 1001 with a square (i.e. 1:1) aspect ratio that is to be displayed in a viewport or visible container having a rectangular (e.g. 9:16) aspect ratio. Accordingly, the scrollable content requires modification (represented by the chevron) into modified scrollable content 1002, to suit the rectangular aspect ratio. The modification may be by the method 900 described herein with reference to FIG. 9.

The scrollable content 1001 includes, in the example shown, five elements and a background. The triangular element is a static element; it includes no scroll-controlled animation. The other four elements each include an animation indicated A to D. Animations A and B are movement animations in which the element moves from the bottom edge of the scrollable content 1001 to the position shown in FIG. 10. The movement is indicated by the arrows. Animation C is a similar movement animation, except from the left edge. Animation D is not a movement animation, for example an animation in which the element appears in place, either instantaneously (e.g. at specific scroll position) or gradually (e.g. fading in/out with scrolling).

In the modified scrollable content 1002, the extent of movement of the animations A and B is lengthened, indicated by the dashed line extensions, as they traverse from the bottom edge of the scrollable content 1001 and the modification has extended that edge. If there was an animation from the top edge, that would similarly be extended. The triangular static element and the elements with animations C and D are not modified, as their display relative to the other elements is not affected by the extension of the background to effect the change in aspect ratio.

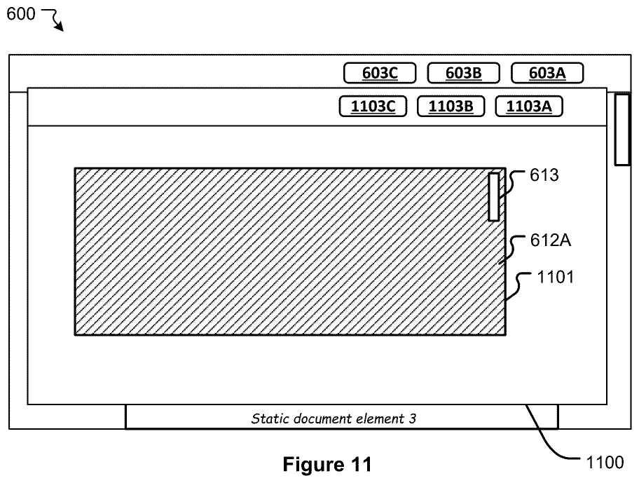

FIG. 11 shows an example screen display of a UI for a user to perform an editing operation of mapped scrollable content (i.e. content based on time-varying content, as described herein) that has been added to a document. The screen display 1100 is described, by way of example, with reference to the UI 600. The screen display 1100 may be displayed responsive to a user input while the screen display of FIG. 6C is displayed, the user input initiating a process for editing the insertable content 612, after it has been inserted into the document 601. For example, the user may have selected the insertable content 612 by a specific selection action or selected the insertable content 612 and then selected a selectable indicium to initiate the editing, which may be one of the buttons 603A, 603B and 603C (e.g. button 603B).

In the example of FIG. 11, the screen display overlays an editor 1100 on the screen display of FIG. 6C. In other examples the editor 1100 is displayed independently. The editor displays content 612A in a display area 1101. In some examples the content 612A is the mapped scrollable content and as such matches the insertable content 612. In some examples the content 612A is time-varying content associated with the insertable content 612. For example, the content 612A may be the original content described with reference to step 301 of the method 300 or the modified original content described with reference to step 305 of the method 300.

The editor 1101 includes selectable indicia for editing the content 612A, in this example three buttons 1103A, 1103B and 1103C. There may be more or less selectable indicia. In examples in which the content 612A is time-varying content, at least one of the selectable indicia edits or initiates a process to edit a timeline of the content 612A. For example, animations or page transitions may be added or their timing changed using the editor 1101, which may maintain a library of such to select from.

One (or more) of the selectable indicia, for example 1103A, may initiate a process for saving the edited content 612A. The edited content 612A may be saved, for example, to the data storage 114. The editor 1100 may also close in response to that selection or may be closed in response to another user action indicating a close request. The computer processing system may perform the method 300 or the method 500 to generate an edited dynamic scrollable document that incorporates the edited content 612A. The computer processing system may also display the edited dynamic scrollable document in the UI 600. The dynamic scrollable document may in turn be saved, for example by selecting the button 603A.

In some examples the content 612A is displayed with the same dimensions as the insertable content 612. These dimensions take account of any cropping that is applied to the insertable content 612. Similarly, any corner rounding or borders applied to the insertable content 612 may be reflected when displaying the content 612A.

In some examples any filtering effects, such as background removal, colour filters, flipping of the media, or blurring or any rich text attributes such as comments, that a user has added to the insertable content 612 are carried across to the content 612A.

The flowcharts illustrated in the figures and described above define operations in particular orders to explain various features. In some cases, the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by different systems or applications.

Unless otherwise stated or required by context the terms “include” and “comprise” (and variations thereof such as “including”, “includes”, “comprising”, “comprises”, “comprised” and the like) are both used inclusively and do not exclude further features, components, integers, operations, steps, or elements.

Unless otherwise stated or required by context the terms “first”, “second”, etc. are used to differentiate between various elements and features and not in an ordinal sense. For example, a first feature could be termed a second feature, and, similarly, a second feature could be termed a feature, without departing from the scope of the described examples.

A recitation of “a”, “an” or “the” is intended to mean “one or more” unless specifically indicated to the contrary. The use of “or” is intended to mean an “inclusive or,” and not an “exclusive or” unless specifically indicated to the contrary.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage, or attribute that is not expressly recited in a claim should be considered as a required or essential feature. Accordingly, the specification and drawings are to be regarded in an illustrative rather than a restrictive sense.

1. A computer implemented method including, by a computer processing system:
receiving, or retrieving from storage, first document content comprising time-varying content, the time-varying content comprising timing information defining one or more events or actions relating to the document content;
generating second document content based on the first document content, the second document content comprising scrollable document content with a scroll distance, wherein the scroll distance is determined by mapping the timing information to the scroll distance.

2. The computer implemented method of claim 1, wherein the timing information defines at least one of: a page transition, an animation, an interaction with an element, a sequential display of portions of a canvas, and a timeline of an embedded video.

3. The computer implemented method of claim 1, wherein the first document content is a presentation document or a recording of a presentation document.

4. The computer implemented method of claim 1, wherein generating the second document content comprises adding timing information to the first document content.

5. The computer implemented method of claim 4, wherein the timing information is added to define at least one of: a page transition, an animation start time, an animation stop time, and an animation duration.

6. The computer implemented method of claim 1, wherein generating the second document content comprises reducing one or more periods of static display in the first document content prior to the mapping.

7. The computer implemented method of claim 1, wherein the scroll distance is linearly mapped to time in at least part of the timing information.

8. The computer implemented method of claim 1, wherein the scroll distance is non-linearly mapped to time in at least part of the timing information.

9. The computer implemented method of claim 1, wherein the scroll distance is based on a viewport height in addition to the timing information.

10. The computer implemented method of claim 1, wherein the scroll distance is based on a scroll distance through a responsive document in which the second document content is displayed.

11. The computer implemented method of claim 1, further comprising displaying the second document content in a fixed position as the scrollable document content is scrolled.

12. The computer implemented method of claim 1, wherein the second document content is displayed in a container that scrolls with the scrollable document content.

13. The computer implemented method of claim 1, further comprising modifying the scrollable document content to suit a viewport with a different aspect ratio than the first document content.

14. The computer implemented method of claim 13, wherein modifying the scrollable document content comprises expanding a background of the scrollable document content and modifying animation data in the scrollable document content.

15. The computer implemented method of claim 1, wherein the first document content is a first document or the second document content is a second document.

16. The computer implemented method of claim 1, further comprising:
receiving a request to edit the second document content;
in response to the request, opening the first document content for editing;
receiving one or more editing requests for the first document content and generating edited first document content;
generating third document content by remapping the edited first document content; and
displaying the third document content.

17. The computer implemented method of claim 1, wherein the step of generating second document content is in response to a request to display the second document content and wherein the scroll distance is based on a height of a viewport, display area or field of view for the second document content.

18. A computer implemented method including, by a computer processing system:
storing in data storage first document content comprising time-varying content, the time-varying content comprising timing information defining one or more events or actions relating to the document content;
receiving a request to display second document content, the second document content comprising mapped content, the mapped content comprising the time-varying content mapped to a scrollable document; and
in response to receiving the request, generating the mapped content.

19. The computer implemented method of claim 18, wherein the timing information defines at least one of: a page transition, an animation, an interaction with an element, a sequential display of portions of a canvas, and a timeline of an embedded video.

20. The computer implemented method of claim 18, wherein the first document content is a presentation document or a recording of a presentation document.

21. The computer implemented method of claim 18, further comprising generating or modifying the second document content to suit a viewport with a different aspect ratio than the first document content.

22. The computer implemented method of claim 18, wherein the first document content is a first document or the second document content is a second document.

23. The computer implemented method of claim 18, wherein a scroll distance of the scrollable document is based on a height of a viewport, display area or field of view for the second document content.

24.-77. (canceled)
